(19) United States
(12) Patent Application Publication
(10) Pub. No.: US 2006/0149544 A1
(43) Pub. Date: Jul. 6, 2006

(54) Error prediction in spoken dialog systems

(75) Inventors: Dilek Z. Hakkani-Tur, Denville, NJ (US); Giuseppe Riccardi, Hoboken, NJ (US); Gokhan Tur, Denville, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/029,278

(22) Filed: Jan. 5, 2005

(51) Int. Cl. G10L 15/00

(52) U.S. Cl. 704/236

(57) ABSTRACT

A spoken dialog system configured to use a combined confidence score. A first confidence score, indicating a confidence level in a speech recognition result of recognizing an utterance, is provided. A second confidence level, indicating a confidence level of mapping the speech recognition result to an intent, is provided. The first confidence score and the second confidence score are combined to form a combined confidence score. A determination is made, with respect to whether to accept the intent, based on the combined confidence score.

### BACKGROUND OF THE INVENTION

1. Field of the Invention

The present invention relates to spoken dialog systems and more specifically to improving error prediction in spoken dialog systems.

2. Introduction

An objective of spoken dialog systems is to identify intents of a speaker, expressed in natural language, and take actions accordingly to satisfy requests. Typically, in a natural spoken dialog system, the speaker's utterance is recognized using an automatic speech recognizer (ASR). Then, the intent of the speaker is identified from the recognized utterance, using a spoken language understanding (SLU) component. This step may be framed as a classification problem for call routing systems. For example, if the user says “I would like to know my account balance”, then the corresponding intent or semantic label (call-type) would be “Request(Balance)”, and the action would be prompting the user's balance, after getting the account number, or transferring the user to the billing department.

For each utterance in the dialog, the SLU component returns a call-type associated with a confidence score. If the SLU component confidence score is more than a confirmation threshold, a dialog manager takes the appropriate action as in the example above. If the intent is vague, the user is presented with a clarification prompt by the dialog manager. If the SLU component is not confident about the intent, depending on its confidence score, the utterance is either simply rejected by re-prompting the user (i.e., the confidence score is less than the rejection threshold) or a confirmation prompt is played (i.e., the SLU component confidence score is in between confirmation and rejection thresholds).

It is clear that the SLU component confidence score is very important for management of the spoken dialog. However, relying solely on the SLU component confidence scores for determining a dialog strategy may be less than optimal for several reasons. First of all, with spontaneous telephone speech, the typical word error rate (WER) for ASR output is about 30%; in other words, one in every three words is misrecognized. Misrecognizing a word may result in misunderstanding a complete utterance, even though all other words may be correct. For example, misrecognizing the word “balance” in an utterance above may negatively effect the SLU component confidence. Second, SLU component confidence scores may depend on an estimated call-type, and other utterance features, such as a length of an utterance in words, or contextual features, such as a previously played prompt.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In a first aspect of the invention, a method in a spoken dialog system is provided. A first confidence score, indicating a confidence level in a speech recognition result of recognizing an utterance, is provided. A second confidence level, indicating a confidence level of mapping the speech recognition result to an intent, is provided. The first confidence score and the second confidence score are combined to form a combined confidence score. A determination is made, with respect to whether to accept the intent, based on the combined confidence score.

In a second aspect of the invention, a spoken dialog system is provided. The spoken dialog system may include a first component, a second component, a third component, and a fourth component. The first component is configured to provide a first confidence score indicating a confidence level in a speech recognition result of recognizing an utterance. The second component is configured to provide a second confidence score indicating a confidence level of mapping the speech recognition result to an intent. The third component is configured to combine the first confidence score with the second confidence score to form a combined confidence score. The fourth component is configured to determine whether to accept the intent based on the combined confidence score.

In a third aspect of the invention, a machine-readable medium is provided that includes a group of instructions recorded therein. The instructions include instructions for providing a first confidence score indicating a confidence level in a speech recognition result of recognizing an utterance, instructions for providing a second confidence score indicating a confidence level of mapping the speech recognition result to an intent, instructions for combining the first confidence score with the second confidence score to form a combined confidence score, and instructions for determining whether to accept the intent based on the combined confidence score.

In a fourth aspect of the invention, an apparatus is provided. The apparatus includes means for providing a first confidence score indicating a confidence level in a speech recognition result of recognizing an utterance, means for providing a second confidence score indicating a confidence level of mapping a speech recognition result to an intent, means for combining a first confidence score with a second confidence score to form a combined confidence score, and means for determining whether to accept an intent based on a combined confidence score.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary spoken dialog system consistent with principles of the invention;

FIG. 2 is a functional block diagram illustrating an exemplary processing system that may be used to implement one or more components of the spoken dialog system of FIG. 1;

FIG. 3 is a flowchart illustrating an exemplary procedure that may be used in implementations consistent with the principles of the invention;

FIG. 4 shows a table that displays properties of training, development, and test data used in experiments;

FIG. 5 illustrates spoken language understanding accuracy for automatic speech recognition and spoken language understanding confidence scores in an implementation consistent with the principles of the invention; and

FIG. 6 is a graph that illustrates accuracy of results in implementations consistent with the principles of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

### Spoken Dialog Systems

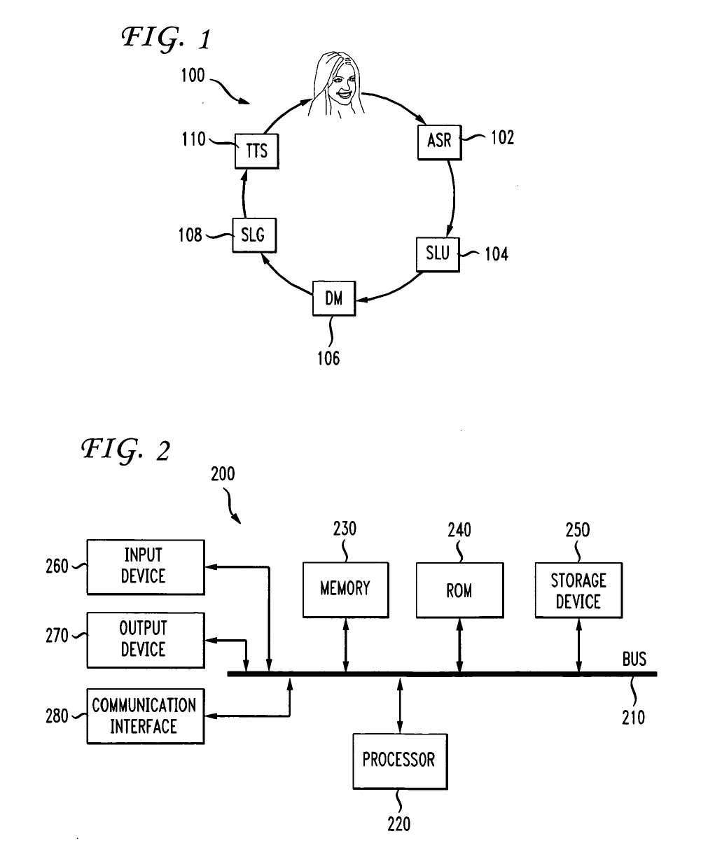

FIG. 1 is a functional block diagram of an exemplary natural language spoken dialog system 100 consistent with the principles of the invention. Natural language spoken dialog system 100 may include an automatic speech recognition (ASR) module 102, a spoken language understanding (SLU) module 104, a dialog management (DM) module 106, a spoken language generation (SLG) module 108, and a text-to-speech (TTS) module 110.

ASR module 102 may analyze speech input and may provide a transcription of the speech input as output. SLU module 104 may receive the transcribed input and may use a natural language understanding model to analyze the group of words that are included in the transcribed input to derive a meaning from the input. DM module 106 may receive the meaning or intent of the speech input from SLU module 104 and may determine an action, such as, for example, providing a spoken response, based on the input. SLG module 108 may generate a transcription of one or more words in response to the action provided by DM module 106. TTS module 110 may receive the transcription as input and may provide generated audible speech as output based on the transcribed speech.

Thus, the modules of system 100 may recognize speech input, such as speech utterances, may transcribe the speech input, may identify (or understand) the meaning of the transcribed speech, may determine an appropriate response to the speech input, may generate text of the appropriate response and from that text, generate audible “speech” from system 100, which the user then hears. In this manner, the user can carry on a natural language dialog with system 100. Those of ordinary skill in the art will understand the programming languages and means for generating and training ASR module 102 or any of the other modules in the spoken dialog system. Further, the modules of system 100 may operate independent of a full dialog system. For example, a computing device such as a smartphone (or any processing device having a phone capability) may have an ASR module wherein a user may say “call mom” and the smartphone may act on the instruction without a “spoken dialog.”

FIG. 1 is an exemplary spoken dialog system. Other spoken dialog systems may include other types of modules and may have different quantities of various modules.

FIG. 2 illustrates an exemplary processing system 200 in which one or more of the modules of system 100 may be implemented. Thus, system 100 may include at least one processing system, such as, for example, exemplary processing system 200. System 200 may include a bus 210, a processor 220, a memory 230, a read only memory (ROM) 240, a storage device 250, an input device 260, an output device 270, and a communication interface 280. Bus 210 may permit communication among the components of system 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to system 200, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive. Communication interface 280 may include any transceiver-like mechanism that enables system 200 to communicate via a network. For example, communication interface 180 may include a modem, or an Ethernet interface for communicating via a local area network (LAN). Alternatively, communication interface 180 may include other mechanisms for communicating with other devices and/or systems via wired, wireless or optical connections.

System 200 may perform functions in response to processor 220 executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

### Overview

In existing spoken dialog systems, once an utterance is recognized, a component, such as, for example, a spoken language understanding (SLU) component may examine each utterance, ŵ=w₁, w₂, . . . wₙ and assign an intent (or a call-type), ĉ(ŵ), to the utterance as well as a confidence score, e(ĉ), obtained from a semantic classifier. This score may be used to guide the dialog strategies. If the intent is not vague and the score is higher than some threshold t₁ (that is, e(ĉ)>t₁), then the call-type assignment may be accepted by the dialog manager, and appropriate action may be taken. If the confidence score is lower than another threshold t₂ (that is, e(ĉ)≦t₂), then the utterance may be rejected, and the user may be re-prompted. If the score is between the two thresholds (that is, t₂<e(c)≦t₁) then the user may be asked a confirmation question to verify the estimated intent. These thresholds may be selected to optimze the spoken dialog performance, by using a development test set, and setting the thresholds to the optimum thresholds for this set.

ASR and SLU confidence scores may be combined to form a combined score to provide an implementation, consistent with the principles of the invention, which is more robust with respect to ASR errors and which improves acceptance, confirmation and rejection strategies during spoken dialog processing. In other implementations consistent with the principles of the invention, other utterance and dialog level information may also be combined with ASR and SLU confidence scores. For example, a length of the utterance (in words), or a call-type, assigned by the semantic classifier, may be combined with ASR and SLU confidence scores to provide a combined score.

### ASR Confidence Scores

ASR confidence scores for each utterance may be computed using the confidence scores of the words in an utterance. For example, ASR module 102 may compute word posterior probabilities for each word wⱼ, of each utterance from a lattice output of an ASR, where j=1, . . . , n. The posterior probabilities may be used as word confidence scores csⱼ for each word wⱼ. The word confidence scores, csⱼ, may be used to assign an ASR score, e(ŵ), to the utterance:
e(ŵ)=f(cs₁, . . . , csₙ)
where f may be, for example, an arithmetic mean function.

One method that may be used to compute word confidence scores may be based on the pivot alignment for strings in a word lattice. A detailed explanation of this algorithm and a comparison of its performance with other approaches is presented in “A General Algorithm for Word Graph Matrix Decomposition,” Proceedings of ICASSP, 2003, by Dilek Hakkani-Tür and Giuseppe Riccardi, herein incorporated by reference in its entirety.

### SLU Confidence Scores

In a commercial spoken dialog system, one objective of an SLU component is to understand the intent of the user. This objective could be framed as a classification problem. Semantic classification may be considered the task of mapping an ASR output of an utterance into one or more call-types. Given a set of examples S={(W₁, c₁), . . . , (Wₘ, cₘ)}, the problem may be to associate each instance WᵢεX into a target label cᵢεC where C is a finite set of semantic labels that are compiled automatically or semi automatically from the data. It may often be useful to associate some confidence score to each of the classes. For example, in a Bayesian classifier a confidence score of a class, cⱼ, is nothing but

$$P ( {c}_{j} \text{\vert} W ) = \frac{P ( W \text{\vert} {c}_{j} ) ⨯ P ( {c}_{j} )}{{\sum }_{i} P ( W \text{\vert} {c}_{i} ) ⨯ P ( {c}_{i} )}$$

A discriminative classifier, for example, Boostexter may be employed in implementations consistent with the principles of the invention. Boostexter is described in “Boostexter: A boosting-based system for text categorization,” Machine Learning, vol. 39, no. 2/3, pp. 135-168, 2000, by R. E. Schapire and Y. Singer, herein incorporated by reference in its entirety. The above discriminative classifier may be an implementation of the AdaBoost algorithm, which iteratively learns simple weak base classifiers. One method for converting the output of AdaBoost to confidence scores uses a logistic function:

$$P ( c = {c}_{j} \text{\vert} W ) = \frac{1}{1 + {ⅇ}^{- 2 ⨯ f ( W )}}$$

where f(W) is a weighted average of the base classifiers produced by AdaBoost. Thus, the SLU confidence score may be:

$$e ( \hat{c} ) \approx {max}_{{c}_{j}} P ( c = {c}_{j} \text{\vert} W )$$

### Combining Scores

The problem of estimating a better confidence score for each utterance may become a classification problem by combining various information sources to find the best function, g, to combine multiple features, and estimate a new score, ns.
ns=g(ŵ, e(ĉ),|ŵ|, ĉ(ŵ))

### Generic Process

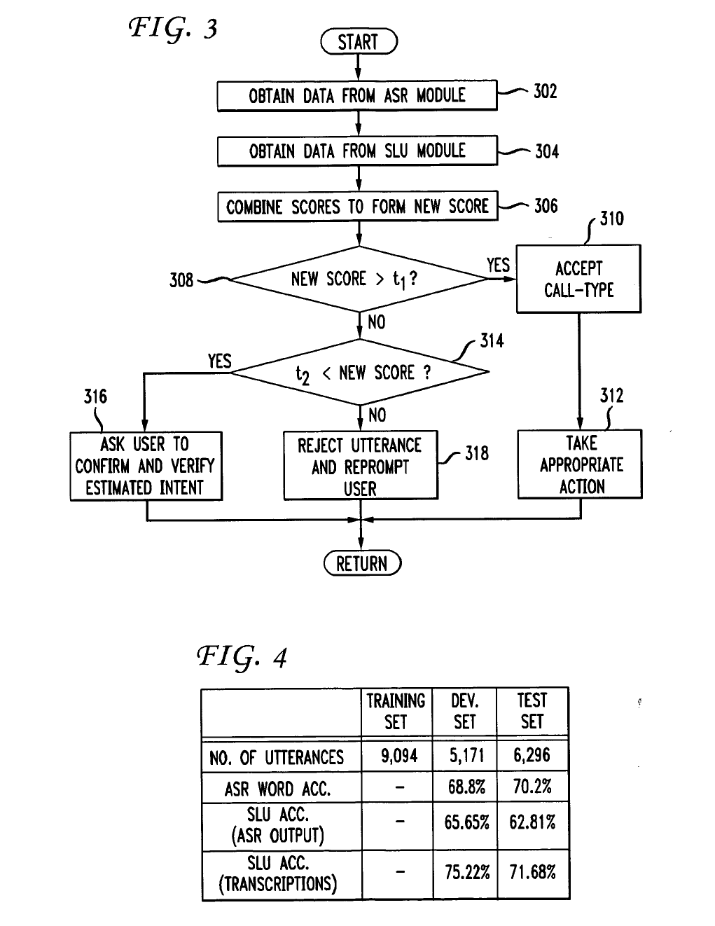

FIG. 3 is a flowchart that explains a generic process that may be used in an implementation consistent with the principles of the invention. The process may begin by a module, such as, for example, DM module 106 obtaining data from, or being provided with, data from ASR module 102 (act 302). The data may include an utterance confidence score, as well as other data. Next, DM module 106 may obtain, or be provided with, an SLU confidence score from, for example, SLU module 104 (act 304). Other data from SLU module 104 may also be obtained or provided. The data from ASR module 102 and SLU module 104 may be combined by a combining component to form a new combined confidence score (act 306) In implementations consistent with the principles of the invention, the combining component may be included in DM module 106 or in SLU module 104.

Next, DM module 106 may analyze the combined score. For example, the new combined score may be compared with a threshold, t₁ (act 308). The thresholds may be real numbers in the range of the confidence scores. For example, if the combined confidence is a real number between 0 and 1, then the threshold should also be between 0 and 1. If the combined score is greater than t₁, then the score may indicate a high confidence level and DM 106 may accept the call-type assigned by the semantic classifier (act 310) and may then take appropriate action (act 312), such as, for example, connecting a user who has a question about certain charges on his bill to the Billing Department.

If the new combined score is less than t₁, then DM 106 may determine whether the new score is less than or equal to a second threshold, t₂, which is lower than t₁ (act 314). If the new score is less than or equal to t₂, then the new score may be unacceptably low and DM module 106 may reject the utterance and re-prompt the user for a new utterance (act 318). If the new score is greater than t₂, but less than or equal to t₁, then DM module 106 may ask the user to confirm the utterance and estimated intent (act 314).

### Score Factorization

In one implementation consistent with the principles of the invention, the combined score may be formed (act 306: FIG. 3) by the combining component by simply multiplying ASR and SLU confidence scores as follows:
ns=e(ŵ)^{α}^{₁}×e(ĉ)^{α}^{₂}
where α₁ and α₂ are scaling factors. The above formula assumes that the ASR and SLU confidence scores are independent from one another. The scaling factors may be determined such that they maxinize the accuracy on a development set.

### Linear Regression

In another implementation consistent with the principles of the invention, the combining component may use linear regression to fit a line to a set of points in d-dimensional space. In this implementation, each feature may form a different dimension. Separate regression parameters, βᵢ for each feature, i, may be learned by using least squares estimation. The combining component may then use linear regression to compute a combined confidence score for utterances, as in the below formula:
ns=β₁+β₂*e(ŵ)+β₃*e(ĉ)+β₄*|ŵ|
where length, |ŵ|, is the number of words in a hypothesized utterance. Thus, in act 302 (FIG. 3), ASR module 102 may provide the number of words in the hypothesized utterance to the combining component, as well as an ASR confidence score for the utterance. In act 306, the above formula, may be implemented within the combining component to compute the combined score.

### Logistic Regression

In yet another implementation, consistent with the principles of the invention, logistic regression may be used by the combining component to calculate a combined confidence score. Logistic regression is similar to linear regression, but fits a curve to a set of points instead of a line. As in the linear regression implementation, in act 302, ASR module 102 may provide the number of words in the hypothesized utterance to the combining component, as well as an ASR confidence score for the utterance. Thus, the combining component, may compute a combined score according to the following formula:

$$ns = \frac{1}{1 + {ⅇ}^{{γ}_{1} + {γ}_{2} * e ( \hat{w} ) + {γ}_{3} * e ( \hat{c} ) + {γ}_{4} * \vert \hat{w} \vert}} ( act 306 \text{:} Fig .3 )$$

Logistic regression parameters, γ₁, γ₂, γ₃, γ₄ may be learned by using the well-known Newton-Raphson Method.

### Decision Trees

In another implementation, consistent with the principles of the invention, the combining component may use decision trees (DTs) to classify an instance of an utterance by sorting down the tree from a root to some leaf node following a set of if-then-else rules using predefined features. In this implementation, continuous features (for example, the confidence scores from ASR module 102 and SLU module 104) may be automatically quantized during decision tree training. Additional features may be used to augment the DTs, such as, for example, a length (in words) of an utterance to be classified. In experiments, various feature sets, such as the length of the utterance, the previous prompt played to the user, etc., have been used, and the probability of an utterance being correctly classified at the corresponding leaf of the decision tree was used as the new combined score (act 306: FIG. 3). These probabilities may be computed from the training set, or a development set. One way of computing the probability of an utterance being correctly classified at the corresponding leaf of the decision tree is by dividing the number of utterances that are correctly classified and ended at that leaf of the tree by the number of all utterances that ended at that leaf of the tree for the training or development set.

### Experiments and Results

A commercial spoken dialog system for an automated customer care application was used, in order to test the approach. There were 84 unique call-types in the application, and the test set call-type perplexity, computed using prior call-type distribution estimated from training data, was 32.64. The data was split into three sets: a training set, a development set, and a test set. The first set was used for training an ASR language model and a SLU model, which were then used to recognize and classify the other two sets. An off-the shelf acoustic model was used. The development set was used to estimate parameters of a score combination function. Some properties of the data sets are given in FIG. 4. SLU accuracy (SLU Acc.) is the percentage of utterances, whose top-scoring call-type is among the true call-types. The top-scoring call-type of an utterance, is the call-type that is given the highest score by the semantic classifier. The true call-types are call-types assigned to each utterance by human labelers.

In order to simulate the effect of this approach in a deployed application, the test set was selected from the latest days of data collection. Therefore there is a mismatch in the performance of the ASR module and the SLU module on the two test sets. A difference in the distribution of the call-types was observed due to changes in customer traffic.

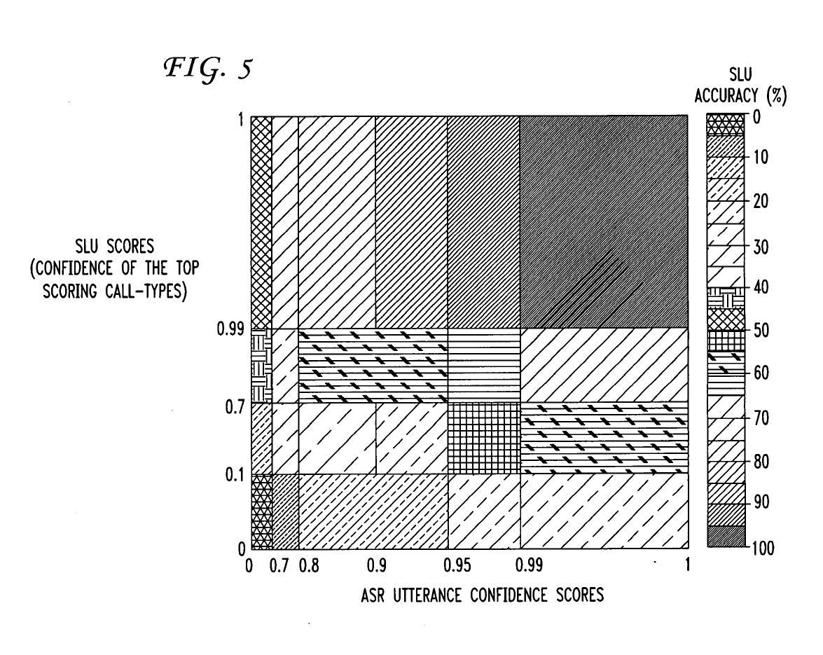

In order to check the feasibility of improving the accuracy of accepted utterances, the SLU accuracy for various ASR and SLU confidence score bins were plotted. FIG. 5 shows a 4-dimensional plot for these bins, where the x-axis is the ASR confidence score bin, and the y-axis is the SLU confidence score bin. The shading of each rectangle, corresponding to these bins, shows the SLU accuracy in that bin, and the size of each rectangle is proportional to the number of examples in that bin. As can be seen from this FIG. 5, when the two scores are high, SLU accuracy is also high. When both scores are low, SLU accuracy is also low. However, when the ASR confidence score is low, SLU accuracy is also low, even though SLU confidence score is high. FIG. 5 confirms that the SLU score alone is not sufficient for determninig the accuracy of an estimated intent.

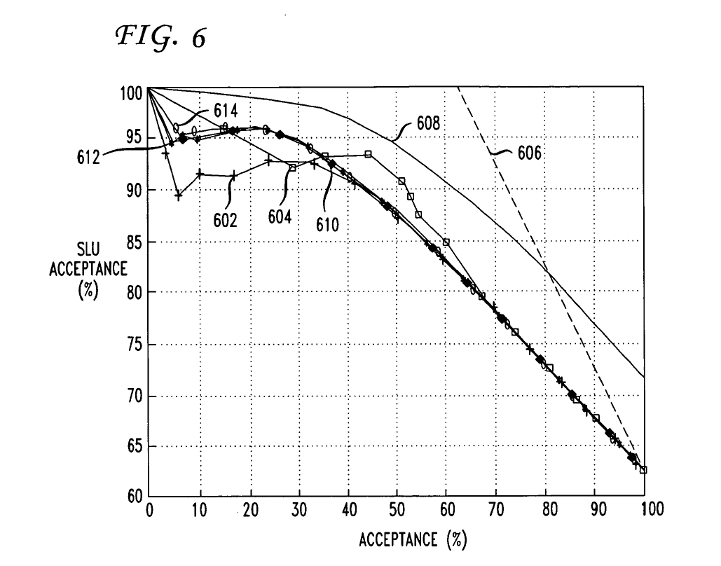

FIG. 6 is a graph that illustrates results of the experiments for combining multiple information sources. The x-axis is the percentage of the accepted utterances, and the y-axis is the percentage of utterances that are correctly classified. The baseline used only the SLU scores for this purpose (plot 602). One upper bound was an experiment, in which all erroneously classified utterances were rejected by comparing them with their true call-types. This was a cheating experiment. The upper bound was computed by comparing the call-types with the true call-types, which are available after manual labeling. The purpose of the upper-bound is to see how much improvement can be obtained if one has perfect combined confidence scores, which is x₁ for all misclassified utterances, and x₂ for all correctly classified utterances and x₁ is smaller than x₂ (plot 606). As another upper bound, a manual transcription of each utterance was used, and the SLU confidence score was used without the ASR confidence score (plot 608). Plot 604 shows results using the DT implementation. Plot 610 shows results using the score factorization implementation. Plot 612 shows results of the linear regression implementation. Plot 614 shows results of the logistic regression implementation. As FIG. 6 shows, all methods for combining features with SLU confidence scores helped to improve the accuracy of the accepted utterances. Multiplication and regression methods performed very similarly, and both resulted in a 4% improvement in accuracy when around 20% of the utterances were accepted without any confirmation prompt. The decision tree implementation outperformed other combination methods for higher acceptance rates.

### Conclusion

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, rmicroprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, in the disclosed implementations, the features were limited to the ASR and SLU confidence scores, utterance length, |ŵ|, and the top scoring call-type associated with the utterance, ĉ(ŵ)). However, many other features can be utilized to help compute a combined confidence score. Accordingly, the appended claims and their legal equivalents should only define the invention, rather than any specific examples given.

We claim as our invention:

1. A method in a spoken dialog system, the method comprising:
providing a first confidence score indicating a confidence level in a speech recognition result of recognizing an utterance;
providing a second confidence score indicating a confidence level of mapping the speech recognition result to an intent;
combining the first confidence score with the second confidence score to form a combined confidence score; and
determining whether to accept the intent based on the combined confidence score.

2. The method of claim 1, wherein the determining whether to accept the intent based on the combined confidence score further comprises:
comparing the combined confidence score to a first threshold; and
accepting the intent when the combined confidence score is greater than the first threshold.

3. The method of claim 1, wherein the determining whether to accept the intent based on the combined confidence score further comprises:
comparing the combined confidence score to a second threshold; and
rejecting the intent when the combined confidence score is less than or equal to the second threshold.

4. The method of claim 3, wherein the determining whether to accept the intent based on the combined confidence score further comprises:
re-prompting a user when the combined confidence score is less than or equal to the second threshold.

5. The method of claim 1, wherein the determining whether to accept the intent based on the combined confidence score further comprises:
comparing the combined confidence score to a first threshold and a second threshold; and
asking a user to confirm a hypothesized utterance from the speech recognition result and an estimated intent from the mapping the speech recognition result to an intent when the second threshold is less than the combined confidence score which is less than or equal to the first threshold.

6. The method of claim 1, wherein the combining the first confidence score with the second confidence score to form a combined confidence score further comprises:
computing the combined confidence score according to: ns=e(ŵ)^{α}^{₁}×e(ĉ)^{α}^{₂}, where ns is the combined confidence level, e(ŵ)is the first confidence score, e(ĉ) is the second confidence score, and α₁ and α₂ are scaling factors.

7. The method of claim 1, wherein the combining the first confidence score with the second confidence score to form a combined confidence score further comprises:
using a linear regression technique to compute the combined score.

8. The method of claim 1, further comprising:
providing a word length of a hypothesized utterance from the speech recognition result, wherein:
the combining the first confidence score with the second confidence score to form a combined confidence score further comprises:
computing the combined score according to: ns=β₁+β₂×e(ŵ)+β₃×e(ĉ)+β₄×|ŵ|, where ns is the combined confidence score, β₁, β₂, β₃, and β₄ are regression parameters, e(ŵ) is the first confidence score, e(ĉ) is the second confidence score, and |ŵ| is the word length of the hypothesized utterance.

9. The method of claim 1, wherein the combining the first confidence score with the second confidence score to form a combined confidence score further comprises:
using a logistic regression technique to compute the combined score.

10. The method of claim 1, further comprising:
providing a word length of a hypothesized utterance from the speech recognition result, wherein:
the combining the first confidence score with the second confidence score to form a combined confidence score further comprises:
computing the combined confidence score according to:
$$ns = \frac{1}{1 + {ⅇ}^{{γ}_{1} + {γ}_{2} * e ( \hat{w} ) + {γ}_{3} * e ( \hat{c} ) + {γ}_{4} * \vert \hat{w} \vert}} ,$$
where ns is the combined confidence level, γ₁, γ₂, γ₃, and γ₄ are regression parameters, e(ŵ) is the first confidence score, e(ĉ) is the second confidence score, and |ŵ| is the word length of the hypothesized utterance.

11. The method of claim 1, wherein the combining the first confidence score with the second confidence score to form a combined confidence score further comprises:
using a decision tree technique to determine the combined confidence score.

12. The method of claim 11, wherein the using a decision tree technique further comprises:
following a set of rules to sort down a tree from a root to a leaf node; and
computing the combined confidence score based on a probability that the intent of the utterance is correctly classified at the leaf node.

13. A spoken dialog system comprising:
a first component configured to provide a first confidence score indicating a confidence level in a speech recognition result of recognizing an utterance;
a second component configured to provide a second confidence score indicating a confidence level of mapping the speech recognition result to an intent;
a third component configured to combine the first confidence score with the second confidence score to form a combined confidence score; and
a fourth component configured to determine whether to accept the intent based on the combined confidence score.

14. The spoken dialog system of claim 13, wherein the third component is included in one of the second component or the fourth component.

15. The spoken dialog system of claim 13, wherein the fourth component is further configured to:
compare the combined confidence score to a first threshold; and
accept the intent when the combined confidence score is greater than the first threshold.

16. The spoken dialog system of claim 13, wherein the fourth component is further configured to:
compare the combined confidence score to a second threshold; and
reject the intent when the combined confidence score is less than or equal to the second threshold.

17. The spoken dialog system of claim 16, wherein the fourth component is further configured to:
re-prompt a user when the combined confidence score is less than or equal to the second threshold.

18. The spoken dialog system of claim 13, wherein the fourth component is further configured to:
compare the combined confidence score to a first threshold and a second threshold; and
ask a user to confirm a hypothesized utterance from the speech recognition result and an estimated intent from the mapping the speech recognition result to an intent when the second threshold is less than the combined confidence score which is less than or equal to the first threshold.

19. The spoken dialog system of claim 13, wherein the third component is further configured to:
compute the combined confidence score according to: ns=e(ŵ)^{α}^{₁}×e(ĉ)^{α}^{₂}, where ns is the combined confidence level, e(ŵ) is the first confidence score, e(ĉ) is the second confidence score, and α₁ and α₂ are scaling factors.

20. The spoken dialog system of claim 13, wherein:
the first component is further configured to provide a word length of a hypothesized utterance from the speech recognition result, and
the third component is further configured to compute the combined confidence score according to: ns=β₁+β₂×e(ŵ)+β₃×e(ĉ)+β₄×|ŵ|, where ns is the combined confidence score, β₁, β₂, β₃, and β₄ are regression parameters, e(ŵ) is the first confidence score, e(ĉ) is the second confidence score, and |ŵ| is the word length of the hypothesized utterance.

21. The spoken dialog system of claim 13, wherein
the first component is further configured to provide a word length of a hypothesized utterance from the speech recognition result, and
the third component is further configured to compute the combined confidence score according to:
$$ns = \frac{1}{1 + {ⅇ}^{{γ}_{1} + {γ}_{2} ⨯ e ( \hat{w} ) + {γ}_{3} ⨯ e ( \hat{c} ) + {γ}_{4} ⨯ \vert \hat{w} \vert}} ,$$
where ns is the combined confidence score, γ₁, γ₂, γ₃, and γ₄ are regression parameters, e(ŵ) is the first confidence score, e(ĉ) is the second confidence score, and |ŵ| is the word length of the hypothesized utterance.

22. The spoken dialog system of claim 13, wherein the third component is further configured to:
use a decision tree technique to determine the combined confidence score.

23. A machine-readable medium having a plurality of instructions included therein, the plurality of instructions comprising:
instructions for providing a first confidence score indicating a confidence level in a speech recognition result of recognizing an utterance;
instructions for providing a second confidence score indicating a confidence level of mapping the speech recognition result to an intent;
instructions for combining the first confidence score with the second confidence score to form a combined confidence score; and
instructions for determining whether to accept the intent based on the combined confidence score.

24. The machine-readable medium of claim 23, further comprising:
instructions for comparing the combined confidence score to a first threshold; and
instructions for accepting the intent when the combined confidence score is greater than the first threshold.

25. The machine-readable medium of claim 23, further comprising:
instructions for comparing the combined confidence score to a second threshold; and
instructions for rejecting the intent when the combined confidence score is less than or equal to the second threshold.

26. The machine-readable medium of claim 25, further comprising:
instructions for re-prompting a user when the combined confidence score is less than or equal to the second threshold.

27. The machine-readable medium of claim 23, further comprising:
instructions for comparing the combined confidence score to a first threshold and a second threshold; and
instructions for asking a user to confirm a hypothesized utterance from the speech recognition result and an estimated intent from the mapping the speech recognition result to an intent when the second threshold is less than the combined confidence score which is less than or equal to the first threshold.

28. The machine-readable medium of claim 23, further comprising:
instructions for computing the combined confidence score according to: ns=e(ŵ)^{α}^{₁}×e(ĉ)^{α}^{₂}, where ns is the combined confidence level, e(ŵ) is the first confidence score, e(ĉ) is the second confidence score, and α₁ and α₂ are scaling factors.

29. The machine-readable medium of claim 23, further comprising:
instructions for providing a word length of a hypothesized utterance from the speech recognition result, and
instructions for computing the combined confidence score according to: ns=β₁+β₂×e(ŵ)+β₃×e(ĉ)+β₄×|ŵ|, where ns is the combined confidence score, β₁, β₂, β₃, and β₄ are regression parameters, e(ŵ) is the first confidence score, e(ĉ) is the second confidence score, and |ŵ| is the word length of the hypothesized utterance.

30. The machine-readable medium of claim 23, further comprising:
instructions for providing a word length of a hypothesized utterance from the speech recognition result, and
instructions for computing the combined confidence score according to:
$$ns = \frac{1}{1 + {ⅇ}^{{γ}_{1} + {γ}_{2} ⨯ e ( \hat{w} ) + {γ}_{3} ⨯ e ( \hat{c} ) + {γ}_{4} ⨯ \vert \hat{w} \vert}} ,$$
where ns is the combined confidence score, γ₁, γ₂, γ₃, and γ₄ are regression parameters, e(ŵ) is the first confidence score, e(ĉ) is the second confidence score, and |ŵ| is the word length of the hypothesized utterance.

31. The machine-readable medium of claim 23, further comprising:
instructions for using a decision tree technique to determine the combined score.

32. An apparatus comprising:
means for providing a first confidence score indicating a confidence level in a speech recognition result of recognizing an utterance;
means for providing a second confidence score indicating a confidence level of mapping a speech recognition result to an intent;
means for combining a first confidence score with a second confidence score to form a combined confidence score; and
means for determining whether to accept an intent based on a combined confidence score.
